(19) United States
(12) Patent Application Publication
(10) Pub. No.: US 2024/0024829 A1
(43) Pub. Date: Jan. 25, 2024

(54) ACCELERATED MIXING AND REACTION KINETICS USING AN ELASTIC INSTABILITY

(71) Applicant: The Trustees of Princeton University, Princeton, NJ (US)

(72) Inventors: Sujit Datta, Princeton, NJ (US); Christopher Browne, Princeton, NJ (US); Richard Huang, Las Vegas, NV (US); Callie Zheng, Princeton, NJ (US)

(73) Assignee: The Trustees of Princeton University, Princeton, NJ (US)

(21) Appl. No.: 18/221,086

(22) Filed: Jul. 12, 2023

Related U.S. Application Data
(60) Provisional application No. 63/388,449, filed on Jul. 12, 2022.

(51) Int. Cl. B01F 23/40; C08J 3/09; B01J 19/30; B01J 19/00; B01F 21/00; B01F 23/451; B01F 35/221; B01F 35/21; B01F 35/71; G01N 21/64

(52) U.S. Cl. CPC B01F 23/405; C08J 3/095; B01J 19/30; B01J 19/0006; B01F 21/02; B01F 23/451; B01F 35/2213; B01F 35/2217; B01F 35/2136; B01F 35/7176; G01N 21/6428; C08J 2333/26; B01J 2219/00162; B01J 2219/00164; B01J 2219/00234; B01F 2101/2805

(57) ABSTRACT

Disclosed are techniques to mimic turbulent-enhanced reactivity under confinement by the addition of dilute high molecular weight polymers. Micro-scale imaging within a transparent porous medium reveals an elastic instability (EI), which drives chaotic fluctuations that stretch and fold solute blobs exponentially in time analogous to turbulent Batchelor mixing, despite the low Re. A reduction in the required mixing length can be observed, suggesting a cooperation between the elastic instability and the dispersion inherent to the disordered 3D porous media—which can be modeled as additive independent mixing rates, representing a dramatic conceptual simplification. The disclosed enhanced transport of solutes circumvents the traditional trade-off between throughput and reactor length, allowing a simultaneous large reduction in length and increases in throughput. Elastic flow instabilities can provide turbulent-like enhancements in chemical reaction rates, which can operate cooperatively with dispersive mixing in industrially relevant geometries.

### CROSS-REFERENCE TO RELATED APPLICATIONS

The present application claims priority to U.S. Provisional Patent Application 63/388,449, filed Jul. 12, 2022, the contents of which are incorporated by reference herein in its entirety.

### TECHNICAL FIELD

The present application is drawn to the field of fluid mixing, and the mixing of liquid fluids utilizing an elastic instability in particular.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Many key environmental, industrial, and energy processes rely on efficient solute mixing within disordered porous media. For example, many groundwater remediation, enhanced oil recovery, and geothermal energy extraction processes rely of the spreading of injection plumes into the surrounding reservoir, and delivery of reactive small-molecule oxidants, bioremediants, or colloids to trapped immiscible phases. Many industrial processes similarly rely on reactive transport of reagents within continuous flow packed beds, gel columns, or heterogeneous catalysts, where the length of a reactor bed bears a significant capital cost and throughput of a reactor limits production rates and profit margins. These processes typically occur at large Damköhler numbers, Da_{I}=tₘᵢₓ/tₘₒₗ>>1, which indicate that reaction progress is limited by the transport of reagents on timescales tin″, much slower than microscopic molecular turnover kinetics tₘₒₗ. The mixing time tₘᵢₓ is a complicated function of the system geometry and fluid dynamics within the reactor. In 3D porous media, mixing is typically dominated by dispersion (large Péclet numbers Pe>>1). Bulk fluid advection drives steady spatial stretching and folding of concentration gradients around solid grains of a characteristic size dₚ, spatially increasing the contact area between solute streams for molecular diffusion and increasing bulk reaction rates over a length scale lₘᵢₓ. Similar insights have been extended to enhance reactive transport in patterned microfluidics. The length scale over which this mixing occurs lₘᵢₓ is nearly constant with imposed flow speed U. Thus, reactions in microfluidics and confined porous media are fundamentally limited by a trade-off between throughput and reactor length: throughput cannot be increased without lengthening the reactor bed, often increasing capital costs dramatically.

For in situ reactions in environmental porous media, where the porous medium cannot be altered, this necessitates drilling of additional environmentally damaging injection wells, increasing the cost of already low-throughput processes. Indeed, these limitations often mean groundwater aquifers remain contaminated for decades after accidental release of toxins, endangering communities, agricultural resources, and ecosystems.

The limitations of dispersion are inherently related to the geometric confinement of the reaction bed. In unconfined bulk tank and pipe flow reactors, turbulence has been used for millennia to enhance mixing and reaction rates. Chaotic velocity fluctuations drive spatiotemporal stretching and folding of concentration gradients, dynamically increasing the contact area between solute streams for molecular diffusion. This flow instability arises when advective inertial stresses overwhelm viscous stresses, characterized by large Reynolds numbers Re=Udₚ/v>>1, where v is the kinematic viscosity of the reagent fluid. Thus, these turbulent enhancements in transport have been fundamentally inaccessible in confined geometries with small dₚ, where Re≤1, and especially where Re<<1.

### BRIEF SUMMARY

Various deficiencies in the prior art are addressed below by the disclosed techniques.

In various aspects, a method for increasing a mixing rate, heat transfer, or reaction rate of fluids may be provided. The method may include providing a polymer solution for use with a geometry of interest having an inlet and an outlet (e.g., a tank, a pipe, soil, etc.). The polymer solution may include a first carrier fluid. The polymer solution may have a high molecular weight (e.g., a molecular weight ≥1 MDa) polymer (such as a flexible polymer that is chemically inert in the target system) dissolved within the first carrier fluid. The polymer may be present in at a dilute (e.g., <0.1 wt %) or semidilute (e.g., <1 wt %) concentration.

The first carrier fluid may be an aqueous fluid. The first carrier fluid may be a non-aqueous fluid. The polymer solution may include one or more salts. The polymer solution may include one or more additional solvents (e.g., in addition to the first carrier fluid). The polymer solution may include an oxidant, a colloid, and/or a surfactant. The high molecular weight polymer may include a polyacrylamide, a polyethyleneoxide, a polylactic acid, or a combination thereof.

The method may include increasing a mixing rate, heat transfer, or reaction rate of the first carrier fluid and a second carrier fluid by producing a microscopic elastic flow instability. The microscopic elastic flow instability may be produced by causing a flow rate and/or decrease in pressure of the first carrier fluid from the inlet to the outlet to exceed a predetermined threshold. Above the threshold, the high molecular weight polymer may autonomously produce the microscopic elastic flow instability.

The method may include dissolving a predetermined amount of the high molecular weight polymer into the first carrier fluid. The method may include adjusting the flow rate and/or decrease in pressure to the extent of improvement, which can be optimized empirically for each application's fluid and geometry.

In some embodiments, causing the flow rate and/or decrease in pressure of the first carrier fluid from the inlet to the outlet to exceed the predetermined threshold may include injecting the first carrier fluid and the second carrier fluid into the geometry of interest at predetermined operating flow conditions.

The method may include modeling various conditions to achieve a desired outcome.

The modeling steps may include estimating the improvement in the rate of mixing or reaction kinetics for a priori process design. The estimating process may include characterizing the rheology of a modified carrier fluid comprising the first carrier fluid and the high molecular weight polymer using a shear rheometer to determine parameters including the shear-dependent normal stress, viscosity, and relaxation time. The estimating process may include determining the shear-dependent Weissenberg number, Deborah number, or Pakdel-McKinley criterion, based on the parameters, to estimate the onset of the elastic instability. The estimating process may include determining a rate of dispersion and/or the dispersion-limited rate of reaction kinetics for the geometry of interest using a previously developed model. The estimating process may include providing an expected total elevated rate of mixing or reaction kinetics as a function of target operating conditions.

In some embodiments, causing a flow rate and/or decrease in pressure may include selecting a target flow rate and/or pressure drop based on the expected total elevated rate of mixing or reaction kinetics expected total elevated rate of mixing or reaction kinetics.

The modeling steps may include considering flow partitioning. The modeling steps may include applying one or more descriptors of a stratified porous medium and one or more descriptors of the polymer solution to an n-layer parallel resistor model for a flow of the polymer solution through the stratified porous medium, where n≥2, computing an onset condition of elastic turbulence in each layer and a nonlinear resistance to flow in each layer, and determining how the flow will partition across layers at a range of operating conditions based on the onset condition and the nonlinear resistance to flow. The modeling steps may include identifying operating conditions that achieve a desired flow partitioning.

The descriptors of the stratified porous medium may include the number of strata, the permeability of each strata, or a combination thereof. The descriptors of the polymer solution may include one or more rheological parameters. The identified operating conditions may include a target rheology of the polymer solution.

The modeling steps may include determining one or more descriptors of a polymer solution, before identifying the operating conditions that achieve a desired flow partitioning, repeating the steps of determining and applying in order to test different polymer solution rheologies before identifying the operating conditions that achieve the desired flow partitioning. The modeling steps may include determining a change to the polymer solution that is required to achieve the desired flow partitioning. The change to the polymer solution may include a change to one or more concentrations within the polymer solution, or the addition or removal of one or more high molecular weight polymers to or from the polymer solution.

In various aspects, a system may be provided. The system may include a first pump configured to inject a polymer solution into a geometry of interest. The system may optionally include a second pump configured to inject a second carrier fluid into the geometry of interest. The system may include at least one sensor configured to measure a pressure and/or a flow rate. The system may include one or more processors configured with instructions that, when executed, causes the one or more processors to, collectively perform several steps. The steps may include receiving information from the at least one sensor. The steps may include controlling the first pump and/or the second pump so as to increase a mixing rate, heat transfer, or reaction rate of a first carrier fluid and a second carrier fluid by producing a microscopic elastic flow instability, the microscopic elastic flow instability being produced by causing a flow rate and/or decrease in pressure of the first carrier fluid from the inlet to the outlet to exceed a predetermined threshold, and allowing the high molecular weight polymer to autonomously produce the microscopic elastic flow instability.

### BRIEF DESCRIPTION OF FIGURES

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is an illustration of a system.

FIG. 2 is a flowchart of a method.

FIG. 3 is a schematic of a porous medium. Two solutions are injected through needles on left into a L=14.7 mm long consolidated packing of dₚ=1 to 1.4 mm diameter glass beads. Dilute fluorescent solutes can be additionally dissolved to visualize passive or reactive cross-stream mixing. For passive mixing experiments stream A may be dyed with, e.g., Rhodamine and stream B may be undyed. For reactive mixing experiments stream A may be dyed with, e.g., reactive SNARF-1 and stream B may be dyed with, e.g., unreactive fluorescein and additionally seeded with co-reactant NaOH.

FIG. 4 is a graph showing concentration variance quantifying the extent of mixing at a given depth. The decay of the concentration variance was fit to an exponential [symbol] e [symbol] ˜exp (−x/lₘᵢₓ), providing fits for a characteristic mixing length lₘᵢₓ and equivalently a mixing rate tₘᵢₓ⁻¹=U/lₘᵢₓ.

FIG. 5 is a graph showing the characteristic length scale of mixing is measured from the exponential decay of the scalar variance [symbol] \tilde{c}² [symbol] _{⊥} over the flow direction x. The polymer-free solvent requires longer mixing lengths at higher throughput (higher Pe), as predicted by established laminar chaotic advection model (blue points and line). In contrast, the polymer solution exhibits a drop in required mixing length above the onset of EI at Wi=λ\dot{γ}_{I}≳1, as predicted by the disclosed model.

FIG. 6 is a series of images showing the deformation of a blob of relatively high solute concentration by the elastic flow instability as it is advected through a pore. Overlaid arrows indicate direction and relative magnitude of velocity fluctuations, which explain the relative deformation of the solute blob.

FIG. 7 is a graph showing Forward finite-time Lyapunov exponents (Γ_{ftle}(x, t)) for an example pore at various Wi, measured from instantaneous velocity fields using open-source software, which computes the exponential rate of separation of virtual tracer particles over the course of one polymer relaxation time λ=480 ms. Cumulative distribution function reported over all pixels and times.

FIG. 8 is a graph showing the pore-scale maximum (90th-percentile value) of the finite time Lyapunov exponents calculated from the dynamic velocity field over the entire spatial and temporal extend of the pore-scale video. Γₘₐₓ increases sharply above Wic to a roughly constant value Γₚₒᵣₑ≈0.13 s⁻¹, representing the mixing capability of the pore-scale flow when concentration gradients enter the pore from upstream.

FIG. 9 is a graph showing the continuous growth of the fraction of time observed in the unstable state is consistent with a power law (Wi−Wi_{c})^{0.25}, providing a fit for Wi_{c}≈1.8 in this pore. The fraction of time exhibiting concentration fluctuations, similarly defined, mirrors this power-law growth (Wi−Wi_{c,S})^{0.25}, but shifted to a larger Wi_{c,S}≈7.4.

FIG. 10 is an illustration showing the superposition laminar and dynamic flow generated by EI.

FIG. 11 is a graph showing reaction progress approaches full conversion (X→1) 4× more rapidly in presence of elastic instability. Squares are for polymer-free solvent, circles are for polymer solution.

FIG. 12 is a graph showing required reactor length increases at higher throughput (Pe) for polymer-free solvent, but decreases for polymer solution in the presence of elastic instability, providing net 75% reduction in reactor length with a simultaneous 20× increase in throughput. Dashed line indicates fit from tᵣₓₙ≈tₘₒₗ+tₘᵢₓ, giving fit for tₘₒₗ≈2 min; solid line gives the disclosed model for increased reaction performance due to EI-enhanced reagent transport.

FIG. 13 is a graph showing scalar breakthrough curves obtained by measuring the normalized dye concentration \tilde{C} at the midpoint x=L/2 over time. Uneven flow partitioning at Wi_{I}=1.4 leads to distinct jumps and prolongs \tilde{C} to long times; by contrast, redirection of flow to the fine stratum at the intermediate Wi_{I}=2.7 leads to more uniform and rapid breakthrough, shown by the smoother and earlier rise in \tilde{C}(\tilde{t}). This homogenization is mitigated at the even larger Wi_{I}=3.3.

FIG. 14 is a graph showing the apparent viscosity, normalized by the shear viscosity of the bulk solution, obtained using macroscopic pressure drop measurements. The apparent viscosity increases above a threshold Wi_{I} due to the onset of elastic turbulence. Measurements for two different homogeneous media with distinct bead sizes and permeabilities show similar behavior. solid line shows the predicted apparent viscosity using a power balance and the measured power-law fit to χ_{t,V} with no fitting parameters; the uncertainty associated with the fit yields an uncertainty in this prediction, indicated by the shaded region. At the largest WiI, the apparent viscosity eventually converges back to the shear viscosity, reflecting the increased relative influence of viscous dissipation from the base laminar flow.

FIG. 15 is a graph showing the extent of flow homogenization generated by elastic turbulence, quantified by the ratio of superficial velocities, does increase with increasing \tilde{k}. Optimal flow homogenization is indicated by the open circles at Wi_{I}=Wi_{I}^{peak} with a velocity ratio (Ũ_{F}/Ũ_{C})^{peak}.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

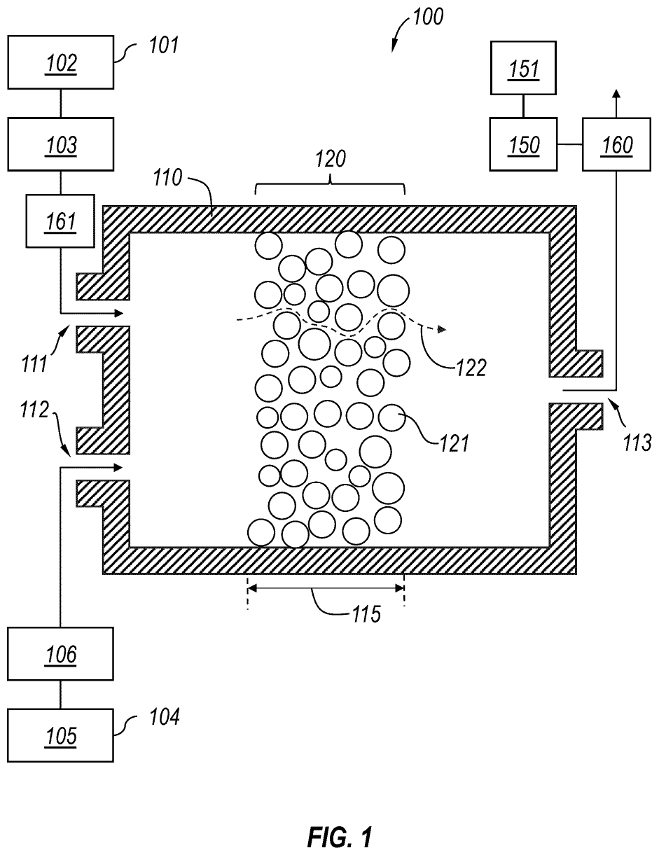

The presently disclosed techniques generally relate to systems having a geometry of interest generally involving the mixing of two fluids, such as two liquids. The systems may utilize porous media. In FIG. 1, a simplified embodiment of a system can be seen. A system 100 may have a first fluid source 101 containing a polymer solution 102. The first fluid source may be operably coupled to a geometry of interest 110. In FIG. 1, the geometry of interest is shown as a generally cylindrical pipe having two inlets 111, 112, and one outlet 113. However, one of skill in the art will understand this geometry may be varied. For example, the geometry may be a batch tank, a region of underground soil, etc.

The geometry of interest may have an intermediate region 120 between an inlet 111 of the polymer solution and an outlet 113 that may include a porous media. Any appropriate porous media may be used here. Here, for example, a plurality of particles 121 are shown in the intermediate region. The particles may be, e.g., glass beads, silica particles, etc. In some embodiments, the porous media may be selected to react with a component of the polymer solution. In some embodiments, the porous media may be selected to be non-reactive with the polymer solution. The fluid(s) flowing through the geometry of interest have a flow path 122 that generally passes through the porous media.

The polymer solution may be provided to the geometry of interest in any appropriate manner. For example, in some embodiments, a pump 103 may be used to convey the polymer solution to the geometry of interest (e.g., via inlet 111)

The geometry of interest may include a second carrier fluid. The second carrier fluid may already be present in the media, or may be introduced in a manner similar to how the polymer solution is introduced. For example, in some embodiments, a second fluid source 104 may be present. The second fluid source may include the second carrier fluid 105. A pump 106 may be used to convey the second carrier fluid to the geometry of interest (e.g., via inlet 112).

The geometry of interest, in addition to containing a porous media, is generally considered to include the volume of space where mixing, heat transfer, or a reaction occurs. For geometries such as that shown in FIG. 1, this can be understood in terms of a length 115 required to achieve a desired level of mixing.

The system may include one or more processors 150. The processors may, collectively, be coupled to one or more sensors 160, 161. The processors may, collectively, be coupled to the pumps 103, 106. The sensor(s) may be any appropriate sensor(s) for measuring a condition relevant to the system. For example, in some embodiments, the sensor(s) include flow rate sensor(s). In some embodiments, the sensor(s) include pressure sensor(s). The processors may be coupled to a non-transitory computer-readable storage device 151.

The storage device may contain instructions that, when executed by the processor(s), cause the processor(s) to perform certain steps. The steps may include receiving information from the at least one sensor. The steps may include controlling the first pump and/or the second pump so as to increase a mixing rate, heat transfer, or reaction rate of a first carrier fluid and a second carrier fluid by producing a microscopic elastic flow instability (EI), the microscopic elastic flow instability being produced by causing a flow rate and/or decrease in pressure of the first carrier fluid from the inlet to the outlet to exceed a predetermined threshold, and allowing the polymer in the polymer solution to autonomously produce the microscopic elastic flow instability.

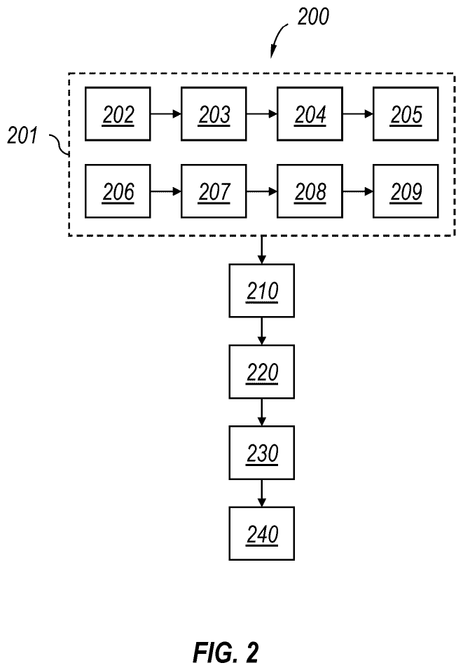

For a given geometry of interest, various techniques may be used to increase a mixing rate, heat transfer, or reaction rate of fluid. Referring to FIG. 2, a method 200 may include providing 220 a polymer solution for use with a geometry of interest (e.g., a tank, a pipe, soil, etc.) as disclosed herein. The geometry of interest may have an inlet and an outlet.

### Example 1—Porous Media Fabrication and Characterization

Most porous media are opaque, precluding direct imaging. To circumvent this limitation, one can fabricate transparent model porous media, allowing one to directly image solute and reactive transport directly within the tortuous 3D pore space. As known in the art, one can pack spherical borosilicate glass beads with diameters uniformly distributed dₚ=1000 to 1400 μm in rectangular quartz capillaries (A=4 mm×2 mm), densify them by tapping, and lightly sinter the beads at 1000° C. for ≈3 min—resulting in a dense random packing with length L=14.7±0.1 mm and void fraction ϕ_{V}˜0.4. One can affix two inlets and two outlets from bent 14-gauge needles, whose outer diameters fit snugly into the rectangular cross-section of the capillary, gluing them into place with a water-tight marine weld (J-B Weld). The inlet needles sit ˜1 mm away from the grains of the porous medium to minimize inlet and outlet effects.

Before each experiment, one can infiltrate the porous medium through both inlets first with isopropyl alcohol (IPA) to prevent trapping of air bubbles and then displace the IPA by flushing with water. One can then displace the water with the miscible test solution—either the polymer solution or the polymer-free solvent. One can inject test fluid(s) through both inlets equally at a constant total volumetric flow rate Q=0.5 to 25 mL/hr using, e.g., a syringe pump.

To ensure an equilibrated starting condition, one can inject at a constant Q for 2.5 hours, corresponding to over 1000 pore volumes t_{PV} ≡ϕ_{V} AL/Q, before any measurements are collected. At the conclusion of the experiment, one can inject rhodamine-dyed polymer-free solvent through both inlets for 6 hours to fully saturate the pore space with dye. One can then image the pore space in all imaged locations. One can binarize and invert the pore space image, and omit the resulting solid grains from all image analyses.

One can estimate the permeability of the medium k by injecting the polymer-free solvent at several flow rates Q=4 to 40 mL/hr and measuring the fully-developed pressure drop ΔP across porous medium using a differential pressure transducer. One can then use a linear fit to Darcy's Law ΔP/L=μQ/(k A) to estimate k. For this example, k=624±3 μm².

The polymer solution may include a first carrier fluid. The first carrier fluid may be an aqueous fluid. The first carrier fluid may be a non-aqueous fluid. In some embodiments, the first carrier fluid may be water. In some embodiments, the first carrier fluid may be an oil. The term “oil” is intended to mean a non-aqueous compound, immiscible in water, liquid, at 25° C. and atmospheric pressure (760 mmHg; 1.013.105 Pa).

The polymer solution may have a high molecular weight polymer. As used herein, the term “high molecular weight” refers to a polymer with a molecular weight ≥1 MDa. The molecular weight of the high molecular weight polymer may be ≥2 MDa. The molecular weight of the high molecular weight polymer may be ≥3 MDa. The molecular weight of the high molecular weight polymer may be ≥4 MDa. The molecular weight of the high molecular weight polymer may be ≥5 MDa. The molecular weight of the high molecular weight polymer may be ≥10 MDa.

The polymer solution may be a dilute solution. As used herein, the term “dilute” solution means a solution of less than 1000 ppm (0.1 wt %). In some embodiments, the concentration C of the polymer in the solution is 10 ppm (0.001 wt %)≤C<1000 ppm (0.1 wt %).

The polymer solution may be a semidilute solution. As used herein, the term “semidilute” solution means a solution of less than 10,000 ppm (1 wt %), but no less than 1000 ppm (0.1 wt %) (i.e., after which, it would be a dilute solution).

The high molecular weight polymer may be a flexible polymer. The term “flexible” polymer means that the flexible polymer will stretch, deform and be capable of building elongational viscosity in a solution.

The high molecular weight polymer may be chemically inert in the target system. In some embodiments, the high molecular weight polymer is not intended to chemically react with any carrier fluid in the system.

The high molecular weight polymer may include a polyacrylamide, a polylactic acid, a polyethyleneoxide, or a combination thereof.

The polymer solution may include one or more salts. The polymer solution may include one or more additional solvents (e.g., in addition to the first carrier fluid). The polymer solution may include an oxidant. The polymer solution may include a surfactant. The polymer solution may include a colloid. In some embodiments, the polymer solution consists of the first carrier fluid, the high molecular weight polymer, optionally one or more salts, optionally one or more additional solvents, optionally an oxidant, optionally a colloid, and optionally a surfactant. In some embodiments, the polymer solution may be free of the one or more salts. In some embodiments, the polymer solution may be free of the one or more additional solvents. In some embodiments, the polymer solution may be free of the surfactant. In some embodiments, the polymer solution may be free of the oxidant. In some embodiments, the polymer solution may be free of the colloid.

### Example 2—Polymer Solution

All test fluids were comprised of a viscous solvent composed of 6 wt. % ultrapure milliPore water, 82.6 wt. % glycerol, 10.4 wt. % dimethylsulfoxide, 1 wt. % NaCl, and <0.1% additional solutes. For ease of imaging, this solution is formulated to precisely match its refractive index to that of the glass beads of the geometry (see Example 1), where n=1.479—thus rendering the porous medium transparent when saturated.

Without the addition of polymers, this solvent has a constant Newtonian viscosity of μ=230 mPa·s, which measured with an Anton Paar MCR301 rheometer, using a 1° 5 cm-diameter conical geometry set at a 50 μm gap over a range of imposed constant shear rates \dot{γ}=0.01 to 10 s⁻¹. One can use this polymer-free solvent as a negative control to establish the baseline mixing performance of laminar dispersion (or “laminar chaotic advection”) through a disordered porous medium.

One can prepare a polymer solution by additionally dissolving, e.g., a dilute concentration cₚ=300 ppm of high molecular weight M_{w}=18 MDa of partially hydrolyzed polyacrylamide (HPAM) into the polymer-free solvent. Full characterization of this test fluid gives an estimate of the overlap concentration c*≈0.77/[η]=600±300 ppm and a radius of gyration of Rg≈220 nm, consistent with previous DLS measurements. The example therefore uses a dilute polymer solution at ≈0.5 times the overlap concentration. The shear stress σ(\dot{γ}_{I})=Aₛ\dot{γ}^{α}^{ₛ} and first normal stress difference N₁ (\dot{γ}_{I})=Aₙ\dot{γ}^{α}^{ₙ} are measured with steady shear rheology in an Anton Paar MCR301 rheometer, using a 1° 5 cm-diameter conical geometry set at a 50 μm gap, yielding the best-fit power laws Aₛ=0.3428±0.0002 Pa·s^{α}^{ₛ} with αₛ=0.931±0.001 and A=1.16±0.03 Pa·s^{α}^{ₙ} with αₙ=1.25±0.02. Since the shear-thinning is minor η˜\dot{γ}^{-0.069}, this fluid is approximately a Boger fluid, and effects like shear-banding or wall slip are not expected to play quantitatively appreciable roles. Nevertheless, one can always use the full η(\dot{γ}) when computing any viscosity-dependent parameters for the polymer solution.

The rheological measurements also enable the estimation of a single polymer relaxation time,

$$λ \approx {lim}_{\dot{γ} \to 0} \frac{{N}_{1}}{2 ( η - {η}_{s} ) {\dot{γ}}^{2}} = 480 \pm 30 ms ,$$

where ηₛ=226.8±0.3 mPa·s is the viscosity of the polymer-free solvent. This relaxation time is in good agreement with previously reported relaxation times for similar polymer and solvent compositions.

In some embodiments, the method may include dissolving 210 a predetermined amount of the high molecular weight polymer into the first carrier fluid.

The method may include increasing 230 a mixing rate, heat transfer, or reaction rate of the first carrier fluid and a second carrier fluid by producing a microscopic elastic flow instability. The microscopic elastic flow instability may be produced by causing a flow rate and/or decrease in pressure of the first carrier fluid from the inlet to the outlet to exceed a predetermined threshold. Above the threshold, the high molecular weight polymer may autonomously produce the microscopic elastic flow instability.

In some embodiments, the flow rate and/or pressure drop threshold may be determined based on a characteristic Weissenberg number Wi. In some embodiments, the flow rate and/or pressure drop may be adjusted so as to cause the Weissenberg number to be above a threshold. In some embodiments, that Weissenberg threshold is about 1. The addition of a dilute high molecular weight polymer drastically improves the mixing performance when the flow is above a threshold Wi≳1, concomitant with the onset of dynamic fluctuations in the concentration field, suggesting an elastic instability in the underlying flow.

In some embodiments, the flow rate and/or pressure drop threshold may be determined based on the Deborah number. In some embodiments, the flow rate and/or pressure drop threshold may be determined based on the Pakdel-McKinley criterion.

### Example 3—Illustrating EI

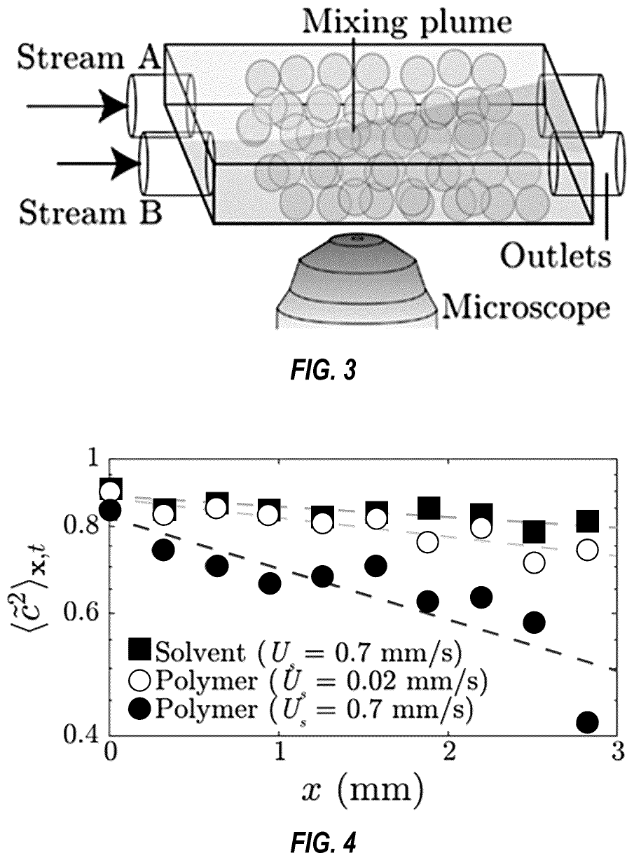

One can fabricate a transparent model porous media as disclosed herein (see Example 1), allowing for directly imaging the pore-scale dynamic flow. To quantitatively assess the coupling between EI and dispersion, one can co-inject streams of dilute fluorescent solutes and image the cross-stream mixing at the macro-scale using confocal microscopy. See FIG. 3. One can perform both passive mixing and reactive mixing experiments in two carrier fluids: a polymer-free solution (−Polymer) as a control to establish the performance of laminar dispersion; and a dilute polymer solution (+Polymer) to assess the combined performance of dispersion and EI.

As a control, one can first quantify laminar dispersion within the porous medium by co-injecting two streams of a viscous Newtonian solution (−Polymer), with a dilute unreactive Rhodamine dye in stream A. At all tested injection speeds, the concentration profile is steady in time, since the flow is laminar at Re=ρUdₚ/μ=10⁻²<<1, where ρ=1.2 g/mL is the solution density. Instantaneous snapshots at the entrance, middle, and exit of the porous medium for U=0.7 mm/s (Pe=Udₚ/D=5·10⁵) show the streams remain poorly mixed by laminar dispersion alone. One can quantify the mixing performance by calibrating fluorescence intensity to local concentration and re-normalizing such that \tilde{c}=+1 corresponds to stream A and \tilde{c}=−1 corresponds stream B.

Specifically, one can monitor the mixing dynamics between the two inlet streams by dying inlet stream A with a dilute concentration c_{A}=500 ppb of fluorescent Rhodamine dye (Rhodamine Red™—X Succinimidyl Ester 5-isomer from Invitrogen), and leave inlet stream B free of any fluorescent dyes c_{B}=0. The dye has an excitation wavelength between 480 and 600 nm with an excitation peak at 560 nm, and emission between 550 and 700 nm with an emission peak at 580 nm. The dyed pore space is imaged using a 561 nm excitation laser, and detected with a 570-620 nm sensor on a Nikon A1R+ laser scanning confocal fluorescence microscope. Choice of this fluorescent marker along with the fluorescent tracer particles allows us to image both dye mixing and the dynamic flow within the pore space at high resolution, with no observable cross talk or bleed through on the laser channels. One can image the dye field at the macro-scale using the confocal galvano scanner with a 4× objective, with a field of view 3167 μm×3167 μm and 8 μm-thick optical slice at a spatial and temporal resolution of 1024 px×1024 px and ½ fps, respectively. One can image successive frames continuously for 3 min at a z depth≈600 μm and 10 successive x depths within the medium, with a 90% overlap between each field of view, which spans the entire L=14.7 mm length of the porous medium.

To relate fluorescence intensity to dye concentration, One can prepare several polymer-free solvents with intermediate Rhodamine concentrations, which can be injected into an empty quartz capillary and image with the same acquisition settings as in experiments. The resulting images have a spatially homogeneous fluorescence intensity, which scales linearly with concentration on the domain of tested c, allowing the computation of c from detected fluorescence emission intensity using the fit. All main text images and data are reported using \tilde{c}.

As the streams mix, the concentration at any pixel is thus given by c_{B}≤c≤c_{A}. Since the two streams are of equal volumetric flow rate Q_{A}=Q_{B}=Q/2 each, they will tend towards a well-mixed concentration c_{∞}=(c₁+c₂)/2. One can then define the dimensionless concentration at any point \tilde{c}(x,t)=(c(x,t)−c_{∞})/(c₁−c₂), which yields \tilde{c}=1 and \tilde{c}=−1 in the dyed and undyed inlets, respectively, and tends to \tilde{c}=0 when the streams are fully mixed.

One can observe dye diffusion upstream of the porous medium. The dyed and undyed streams meet along a thin fluid lamella of well-mixed fluid. Diffusion of the dye across this concentration gradient causes this lamella to grow in thickness—though in this experiment, this diffusive mixing only occurs on an expected length scale of \sqrt{ [symbol]Lₑ/U}˜1 μm over the entrance length of Lₑ≈1.5 mm, and an expected length scale of \sqrt{ [symbol]Lₑ/U}≈5 μm over the medium length. Instead, mixing within the porous medium at Pe≈10⁵ to 10⁶>>100 is dominated by dispersion: the tortuous flow through the 3D pore space stretches and folds this lamella of high-concentration gradient ∇\tilde{c} into multiple lamellae, providing more regions of high diffusive flux [symbol] ∇\tilde{c}. As a result, there are several bands of well-mixed fluid downstream of the porous medium, many still centered near the middle of the channel.

To quantify this improvement in the extent of mixing, one can measure the distribution of \tilde{c} across each instantaneous field of view, using the pore space image to omit regions occupied by the solid grains. At the entrance to the porous medium, the distribution is bimodal with peaks at \tilde{c}=−1 and \tilde{c}=+1 for both fluids at U=0.7 mm/s, corresponding to the undyed and dyed streams, respectively. At successive depths, the two peaks broaden as the dyed and undyed streams mix, leading to an increased proportion of well-mixed fluid at \tilde{c}=0.

For the polymer solution, these peaks broaden much faster, and develop a new peak that begins to grow around \tilde{c}≈0 after a depth of x≈13 mm, representing a significant portion of the fluid is well-mixed. One can characterize the approach to the well-mixed state using the variance of the concentration [symbol] \tilde{c}² [symbol] x,t, where the average is taken spatially over one field of view and across all time points. The variance starts close to [symbol] ć² [symbol] x,t≈1, corresponding to completely unmixed streams, and decreases towards [symbol] \tilde{c}² [symbol] x,t→0, corresponding to a single well-mixed stream (see FIG. 4). One can fit the spatial decay of [symbol] \tilde{c}² [symbol] x,t to an exponential˜exp (−x/lₘᵢₓ), yielding a characteristic mixing length of lₘᵢₓ=29 mm, or equivalently a mixing rate of τ⁻¹=U/lₘᵢₓ=1.5 min⁻¹.

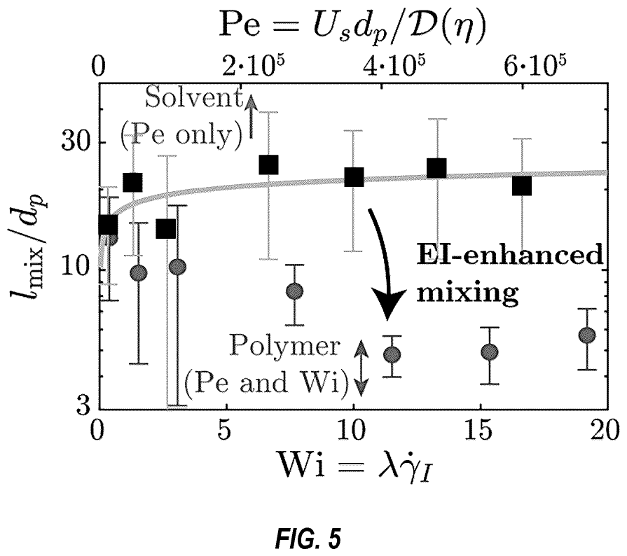

For changes in U, no appreciable changes were observed in lₘᵢₓ (see FIG. 5). This is expected, since the dye Péclet number is large Pe=Udₚ/ [symbol] _{d}>10⁴>>100, indicating that the dispersion inherent to the porous medium dominates over diffusion. The dispersion of a disordered porous medium occurs by the spatial stretching and folding of lamellae of large ∇\tilde{c} as they spatially advect through the tortuous 3D pore space (sometimes termed “laminar chaotic advection”), and is known to be insensitive to imposed flow speed. Thus, the dispersive mixing of a Newtonian fluid in a porous medium has a limiting mixing length lₘᵢₓ, which cannot be further lowered by increasing the flow speed. Consistent with this model of mixing, the polymer-free solvent exhibits slightly poorer mixing and higher lₘᵢₓ with increasing Pe, reflecting that for Newtonian solutions mixing performance is a function of the medium geometry itself.

In contrast, the polymer solution exhibits a strong enhancement in mixing performance and decrease in lₘᵢₓ with increasing Pe. To quantify this apparent improvement in instantaneous mixedness, we again measure the distribution of instantaneous concentrations within each field of view (see FIG. 5). Near the entrance of the porous medium, the polymer solution remains mostly unmixed, characterized by a bimodal distribution \tilde{c}=−1 and \tilde{c}=+1. However, at successive depths the two peaks broaden much faster than observed for the polymer-free solvent; after a depth of x≈13 mm, a peak can be observed that begins to grow around \tilde{c}≈0, representing a significant portion of the fluid is well-mixed.

One can again quantify the merging of these distributions toward the well-mixed \tilde{c}=0 state using [symbol] \tilde{c}² [symbol] x,t, which decreases exponentially with a shorter mixing length of lₘᵢₓ=5.9 mm, a 5× factor of improvements compared to the polymer-free solvent. Testing the mixing length at multiple imposed flow speeds shows a strong dependence of lₘᵢₓ on U for the polymer solution—indicating that laminar dispersion is no longer completely dominating the mixing performance, since laminar dispersion by a porous medium does not depend on U for these high Pe. Consistent with this expectation, the onset of this enhanced mixing performance is concomitant with observations of concentration fluctuations: below Wi≲1, the mixing length of the polymer solution closely mirrors the polymer-free solvent, and the concentration field remains steady, indicating a laminar underlying flow. Above Wi≳1, lₘᵢₓ decreases in this example by ≈5×, and the concentration field exhibits fluctuations that grow in intensity with increasing Wi, suggesting an unsteady underlying flow. Thus, the disclosed polymer solution exhibits a strong enhancement in mixing performance that is seemingly linked to the onset of an elastic instability.

The distribution of \tilde{c} quantifies the amount of fluid that is well mixed \tilde{c}≈0 at successive depths within the medium x. As is standard, one can quantify the mixing performance using the variance about zero [symbol] \tilde{c}² [symbol] (see FIG. 4), which decays exponentially in space˜exp (−x/lₘᵢₓ), giving us an estimate for the characteristic length lₘᵢₓ over which laminar dispersion of the porous medium mixes the solute streams (see FIG. 5). For the laminar mixing of Newtonian fluids at Pe≳10, mixing is dominated by advective dispersion of lamellae of high ∇\tilde{c}, where microscopic mixing proceeds by molecular diffusion. In this limit, the mixing length is predicted to scale as lₘᵢₓ˜dₚ ln (Pe) (solid line in FIG. 5 consistent with the measurements. The slight increase in the curve reflects the fact that mixing performance is determined primarily by the geometry of the porous medium itself, and increases in flow speed or Pe tend to hinder, rather than aid, the extent of mixing.

In contrast, addition of a dilute concentration (about half of overlap concentration) of a high molecular weight (see Example 2, e.g., M_{w}=18 MDa hydrolyzed polyacrylamide (HPAM)) drastically enhances the mixing of the solute streams. The concentration fields fluctuate dynamically, indicating the flow is no longer laminar at the same imposed flow conditions. Quantifying the mixing length as before, the polymer solution exhibits similar mixing performance with the polymer-free control at low Pe, but a dramatic 80% drop at higher Pe (see FIG. 5).

To characterize the strength of elasticity in our flows, one can define a characteristic Weissenberg number Wi=λ\dot{γ}_{I} from the characteristic relaxation time λ=480±30 ms (as disclosed in Example 2), and the characteristic shear rate in the pore throats \dot{γ}_{I}=ϕ_{V} Uₛ/\sqrt{k/ϕ_{V}} (second abscissa axis on FIG. 5), where ϕ_{V}≈0.4 and k=624 μm′ are the void fraction and permeability of the porous medium, respectively (see Example 1). Over the tested \dot{γ}_{I}, the fluid is approximately Boger, with little shear thinning η˜\dot{γ}^{-0.07}. At low Wi=0.5, the concentration field is laminar and steady in time, closely mirroring the polymer-free solvent. At higher Wi=1.5, the concentration exhibits spatiotemporal fluctuations that increase at successively higher Wi. Thus, an observed improvement in passive solute mixing appears to be linked to the onset of a purely-elastic flow instability.

This hypothesis can be tested by simultaneously monitoring the solute concentration field \tilde{c}(x, t) and the velocity field u(x, t) at the single pore scale by additionally seeding test fluids with dilute fluorescent solid tracer particles and tracking their positions using particle image velocimetry. As is the case for all Newtonian fluids at Re<<1, our polymer-free solvent remains laminar at all tested flow rates. In contrast, our polymer solution transitions to an unstable, turbulent-like flow above a threshold Wig, consistent with our previous observations. This elastic flow instability (EI) is characterized by chaotic velocity fluctuations, with energy spectra that decay as power laws lacking any spatial or temporal scale. To quantify these fluctuations, one can subtract off the temporal mean u′=u− [symbol] u [symbol] ₜ and compute the root mean square fluctuation u′ᵣₘₛ=\sqrt{ [symbol]u′|² [symbol] ₜ} The pore scale flow remains laminar and steady in time for Wi=0.4 and 1.5. At an intermediate Wi=2.9, the velocity field exhibits intermittent bursts of deviating velocity, which grow in frequency and irregularity at successively higher Wi=7.4 to at least 18. One can track this intermittency as the fraction of time observed in the unstable state, which grows continuously above a critical Wi_{c}≈1.8—mirroring previous observations for elastic instabilities in experiments and theory, and for inertial turbulence, where this growth suggests a 2nd-order percolation-driven transition to the unstable state. This fit provides an estimate for Wi_{c}≈1.8 in this pore. Previous work has established that this Wi_{c} may vary pore-to-pore, from e.g., Wi=λ\dot{γ}_{I}≈1.6 to 9.2; at intermediate Wi, unstable and stable pores coexist.

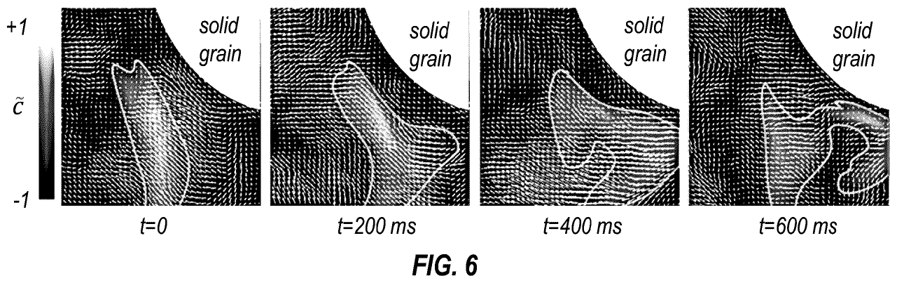

These pore-scale velocity fluctuations drive fluctuations in the concentration field as well. Similar to fluctuations in the velocity field, it can be confirmed that the solute concentration fluctuations are chaotic by measuring their spatial and temporal power spectra, which also follow power-law decays lacking characteristic length or time scales. One can investigate the coupling between the velocity field and concentration field in detail at, e.g., Wi=7.4, discrete blobs of relatively high \tilde{c} intermittently enter this example pore, allowing one to directly track how velocity fluctuations deform solute concentration gradients. FIG. 6 shows snapshots of one such deformation process as a discrete solute blob advects with the mean flow from the top left towards bottom right of the pore. Velocity fluctuations directly counter to the mean flow stretch the upper tip of the blob up and to the left (t≈200 ms). Then, a left-ward fluctuation which further stretches and begins to bend the blob horizontally (t≈400 ms). Finally, leftward and downward velocity fluctuations on the left and right side of the blob provide a net shearing motion, which folds the blob into an elongated, corrugated structure (t≈600 ms). As a result of this stretching and folding, the in-pane contour surrounding the blob l—and approximated 2D surface area≈l²—grows exponentially in time with a rate of ≈1.7 s⁻¹=1/(1.2λ).

A similar exponential growth in blob surface area occurs in turbulent flows within the Batchelor mixing regime at Pe>>1. In this regime, turbulent flow dynamically advects concentration gradients ∇c faster than diffusion can smooth them out. Since solute transport at the microscopic scale only occurs by this diffusive flux [symbol] ∇c, the macro-scale mixing of the solute is apparently limited by the surface area of these “transport lamellae”. This is reflected in the variance transport equation:

$$\frac{{d ( {\tilde{c}}^{2} 〉}_{⊥}}{dt} = 〈 {\vert ∇ \tilde{c} \vert}^{2} {〉}_{⊥} \qquad ( 1 )$$

Which is solved by [symbol] \tilde{c}² [symbol] _{⊥}=exp (−tτₘᵢₓ⁻¹), where the macro-scale mixing rate τₘᵢₓ depends on the number of folding steps n applied to the transport lamellae of ∇\tilde{c}. In turbulence, the number of folds grows exponentially in time n(t)˜exp(tΓ), where F is the largest Lyapunov exponent, an inherent property of a chaotic flow, implying τₘᵢₓ⁻¹≈Γ.

Observations of stretching and folding of ∇\tilde{c}lamellae at the sub-pore scale are consistent with previous work, which shows that elastic flow instabilities can drive Batchelor-regime turbulent-like mixing of passive solutes in simple shear and curvilinear channel flows and in 2D pillar arrays. The disclosed results confirm this expectation that elastic flow instabilities can provide Batchelor mixing of solutes at the single pore scale within a disordered 3D porous medium.

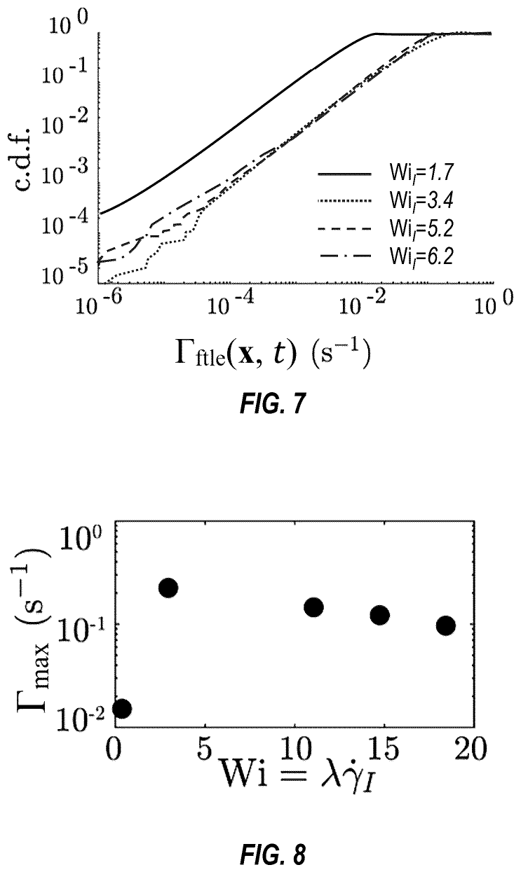

One can estimate the characteristic rate of stretching using open source software, which computes forward finite-time Lyapunov exponents Γ_{ftle}(x, t) (see FIG. 7). The maximum value Γₘₐₓ over space and time within this pore most closely approximates the largest Lyapunov exponent, and hence serves as the dominant stretching rate. FIG. 8 shows that above the onset of EI at Wi_{c}≈1.8, Γₘₐₓ jumps to a nearly constant value Γ_{EI}≈0.13 s⁻¹=1/(15λ), which we take as a characteristic dominant stretching rate for unstable pores. This value is consistent with previous observations that γ_{EI}˜λ₀⁻¹, where λ₀ is 0, the longest polymer relaxation time, which can be anticipated to be approximately an order of magnitude larger than the estimated characteristic relaxation time λ. Thus, when blobs of relatively high (or relatively low) solute concentration enter a pore above its threshold Wi_{c}, the elastic flow instability produces chaotic Batchelor mixing at rate γ_{EI} at the sub-pore scale.

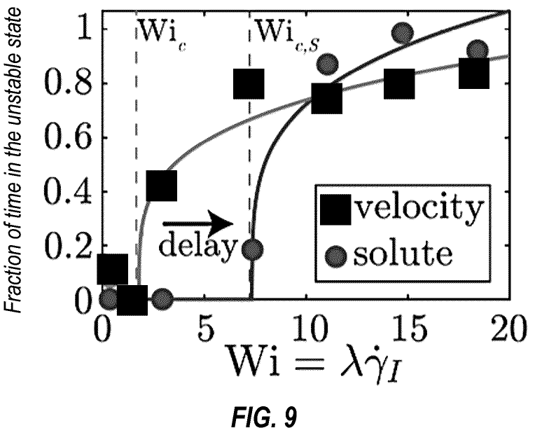

Surprisingly, however, this enhancement in solute mixing is not directly concomitant with the onset of EI—in direct contrast to previous observations in channel flows and 2D pillar arrays. Instead, videos of the instantaneous concentration \tilde{c}(x, t) and maps of \tilde{c}ᵣₘₛ′=\sqrt{ [symbol]\tilde{c}² [symbol] ₜ} show a significant delay between the observed velocity fluctuations at Wi=2.9 and observed solute concentration fluctuations at Wi=7.4. Below Wi=7.4, no solute enters the pore, and so no concentration fluctuations are observed. At Wi=7.4, upstream mixing processes intermittently advect blobs of relatively high \tilde{c} into the pore, which are deformed dynamically by the unstable flow as they advect. At successively higher Wi=11 to 18, the advection of \tilde{c} blobs into the pore and the deformation of them in transit increase in persistence and irregularity—mirroring the intermittent transition to instability in the velocity field, but with a shift in the critical value to Wi_{c,S}=7.4 (see FIG. 9). This delay highlights the key distinction between the velocity and concentration fields in a disordered porous medium. Even though the solute field is slave to the velocity field, velocity fluctuations can only produce measurable concentration fluctuations if concentration gradients enter the pore. The advection of concentration gradients into a given pore is inherently linked to the macro-scale unstable flow through the disordered porous medium, which is known to exhibit significant pore-to-pore variability in Wi_{c}.

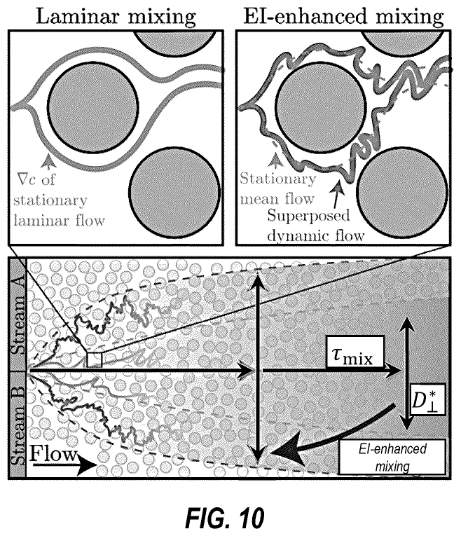

Recent work suggests that mixing associated with advective dispersion of a 3D porous medium can be understood similarly as a Batchelor mixing process at scales larger than the pore-size. Laminar chaotic advection of concentration gradients ∇\tilde{c} drive spatial, rather than dynamic, stretching and folding of the solute stream interface, which grows in interfacial area exponentially in time with a rate τ_{mix,D}⁻¹≈Uₛ/lₘᵢₓ. Given this separation of scales between the stretching and folding of EI at the sub-pore scale and advective dispersion at the multi-pore scale, it is assumed that these two folding processes occur independently and can be superposed (see FIG. 10).

Both mixing processes exhibit Batchelor mixing at their respective scales, for which the mixing rate is modeled by the number of successive folds added to transport lamellae n, which increase exponentially in time˜exp (t/τₘᵢₓ). Thus, superposition of both mixing modes leads to multiplicative folds n≈n_{D}×n_{EI}, and equivalently colligative rates τₘᵢₓ⁻¹≈τ_{mix,D}⁻¹+τ_{mix,EI}⁻¹. This combined mixing rate then drives the collective expansion of a plume of concentration gradients ∇\tilde{c}(see FIG. 10).

One can estimated the macro-scale contribution of EI by averaging the pore-scale contribution over steady and unsteady pores, τₘᵢₓ⁻¹≈ [symbol] Γ_{EI} [symbol] (Wi>Wi_{c}) [symbol] (y<r₀\sqrt{xU/D_{⊥}*}) [symbol] _{V} The conditional probabilities [symbol] indicate the joint probability that a pore is (i) above its onset of EI and (ii) within the plume of transport lamellae, such that velocity fluctuations manifest in solute concentration stretching and folding. Previous literature suggests Wig are not spatially-correlated and Γ_{EI}≈λ₀⁻¹ is a property of the polymer solution independent of local pore geometry. These simplifications yield the expression τ_{mix,EI}⁻¹≈γ_{EI}f_{EI}f_{P}, where f_{EI}(Wi) is the fraction of pores above the onset Wi_{c} taken from the cumulative distribution function, and f_{P}=V_{P}/VPV is the fraction of the porous medium within the dispersion plume of transport lamellae, which grows by the combined action of dispersion and EI.

To map the growth of this ∇\tilde{c} plume, one can compute the gradient of the solute concentration \tilde{∇}\tilde{c}=d_{P}⁻¹ (∂ₓ+∂_{y})\tilde{c} at the macro-scale. Below the onset of EI, lamellae of high \tilde{∇}\tilde{c} are steady in time, passing through relatively few pores by laminar dispersion. Above the onset of EI in select pores at Wi_{c,min}, these transport lamellae fluctuate in time, dispersing into a broader plume, which widens at successively higher Wi. The width of this plume of transport lamellae was characterized by tracking the position-weighted variance δ(x)= [symbol] y· [symbol] \tilde{∇} [symbol] ₜ² [symbol] _{y}. The width of this plume grows as δ(x)=D_{⊥}*\sqrt{x}, and from this fit one can measure D_{⊥}*, the effective dispersion coefficient for the transport lamellae. for the transport lamellae. This effective dispersion coefficient of transport lamellae is distinct from the actual dispersion coefficient of the solute itself D_{⊥}≈τₘᵢₓ⁻¹d_{P}², which could be measured from a single narrow injection source rather than the two co-flowing streams in FIG. 3. Nevertheless, a similar scaling D_{⊥}*˜τₘᵢₓ⁻¹d_{P}² is observed across experiments at different Wi. The volume of pores contained within this plume of transport lamellae therefore grows as V_{P}=πr₀²UL²/D_{⊥}*˜πr₀²UL²τₘᵢₓd_{P}⁻², where r₀≈8 μm is the initial width of the single transport lamella entering the medium.

Rearranging the model for lₘᵢₓ shows good agreement with measured mixing rates (see FIG. 5), indicating that the onset of EI at Wi_{c,min} coincides with a gradual improvement in the macro-scale mixing rate, which saturates at an 80% decrease in lₘᵢₓ at Wi_{c,max}≈10, when roughly all pores reach their EI threshold.

A multi-scale image of EI-enhanced mixing thus emerges. At low Wi the flow is laminar, and mixing proceeds by the steady dispersion of transport lamellae. Above Wi_{c,min}, EI leads to velocity fluctuations within individual pores scattered throughout the porous medium. When an unstable pore intersects with the dispersion plume of transport lamellae, a chaotic pore-scale mixing processes akin to Batchelor-regime mixing stretches and folds concentration gradients, dynamically expanding the dispersion plume of transport lamellae. This dispersion is compounded by additional pores reaching their Wi_{c} onset of EI. At Wi_{c,max}, all pores are unstable and provide enhanced pore-scale mixing at rate Γ_{EI}.

### Example 4—Reaction Rates

Mixing enhancements associate with turbulence have been used for millennia to enhance chemical reaction rates, and quantitative control of this enhancement has been a mainstay of the chemical synthesis industry for well over a century. The disclosed technique to induce an elastic instability with dilute polymers has the potential to recapitulate these turbulent-like enhancements in chemical reaction rates within these confined geometries at arbitrarily low Re. To test this capability, a model reaction was developed with a fluorogenic reagent and product that allows direct visualization of the instantaneous reaction progress within our disordered porous medium.

The model chemical reaction is the reduction of a fluorescent dye SNARF from its phenolic form HSf to phenolate form Sf⁻. In the presence of excess sodium hydroxide NaOH, the reversible reaction proceeds rapidly to the right with negligible back-reaction, making it effectively an irreversible transport-limited reaction:

HSf+OH⁻→Sf⁻+H₂O (2)

Under 488 nm excitation, the fluorophore has an emission peak shift from 586 nm to 636 nm, allowing direct visualization of the instantaneous concentrations of both the phenolic reactant and phenolate product within the disclosed 3D porous medium (see, e.g., Example 1). The phenolic reactant HSf in stream A and excess sodium hydroxide in stream B were coinjected at equal flow rates Q_{A}=Q_{B}, which mix and react to form the phenolate product downstream.

A thin band of the phenolate product Sf⁻ was observed at their interface—indicating a reaction depth of ≲10 μm due to the cross-diffusion and reaction of the two reagents before entering the porous medium. For the polymer-free solvent, the laminar flow results in a temporally-steady concentration field of reagents. As a result, the reaction proceeds only along relatively thin bands where the reagent streams are well-mixed by the laminar dispersion of the pore-space. In contrast, the polymer solution exhibits strong fluctuations in the reagent concentration fields due to the elastic instability, and a much higher concentration of the product Sf⁻ is produced across the width of the porous medium at earlier depths. This strong increase in product concentration suggests that the enhanced mixing associated with the elastic instability in accelerating the chemical reaction, producing stronger conversion of reactants into products at earlier times and shorter depths within a porous medium.

To quantify this acceleration of chemical reaction rate, the reaction progress can be computed as the fraction of reactant converted into product, X=[Sf⁻]/[HSf]₀ from calibration curves.

To accurately calibrate for the moderate bleed-through and change in fluorescence intensity, a series of calibration standards were made with [HSf]₀=5 μM at various buffered intermediate pH values. 1 mM Tris-base buffered against hydrochloric acid were used to obtain the full experimental range pH=7 to 10. At each pH, the reaction reaches an equilibrium defined by its pK_{b}=−log (K_{b}): Kb=[HSf][OH⁻]/[Sf⁻].

Within the calibration experiment, stoichiometric conservation additionally imposes [HSf]₀=[HSf]+[Sf⁺], and [OH]=10^{-pOH}, since the solution is buffered. These calibration standards were imaged in an empty quartz capillary at the same image acquisition settings as done for various experiments, which give homogeneous images of different colors, depending on the pH. An error function was fit to the data give an estimate for the pKₐ=14−pK_{b}=8.7. The relative fluorescence intensity in each channel F_{C}/F_{R} can then be determined, as well as the total fluorescence intensity F_{C}+F_{R}, to the known equilibrium concentrations of [HSf] and [Sf⁻] to produce a calibration standard for the reaction conversion X=[Sf⁻]/[HSf]₀ as a function of the relative fluorescence intensity F_{C}/F_{R}.

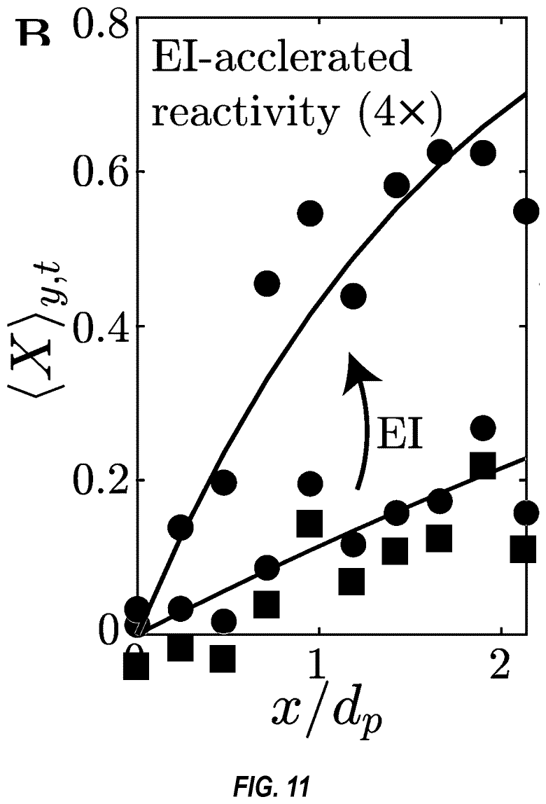

One can average over time and space for each field of view at successive depths within the porous medium, and measure the growth in macro-scale reaction progress from [symbol] X [symbol] _{y,t} (x=0)≈0 at the inlet and [symbol] X [symbol] _{y,t} (x→∞)→1 as the reaction approaches completion near the outlet. See FIG. 11. In the presence of the elastic instability in the polymer solution, the fluctuating interface of reagents results in a higher conversions across the entire width of the medium, suggesting that the improved spatial mixing of reagents results in higher reaction rates. The growth in conversion can be fit to an exponential [symbol] X [symbol] _{⊥}(x)=1−exp(−x/(Utᵣₓₙ)), from which one can measure the effective reaction length within the continuously advected flow tᵣₓₙ⁻¹. As expected, below the onset of EI, both the polymer solution and the polymer-free solvent have a low effective reaction rate tᵣₓₙ⁻¹≈0.2 min⁻¹, and a characteristic reaction length of lₘᵢₓ≈4dₚ. The polymer-free solvent exhibits slower reaction rates and an increased reaction length at successively larger Pe, consistent with the traditional trade-off between throughput and required reactor length. In contrast, above the onset of EI, the polymer solution exhibits a decrease in the required reactor length. Consistent with this hypothesis, the measured 5× enhancement in mixing rate from the passive solute experiments at similar conditions well-predicts the 4× acceleration of reaction rates for the model reaction.

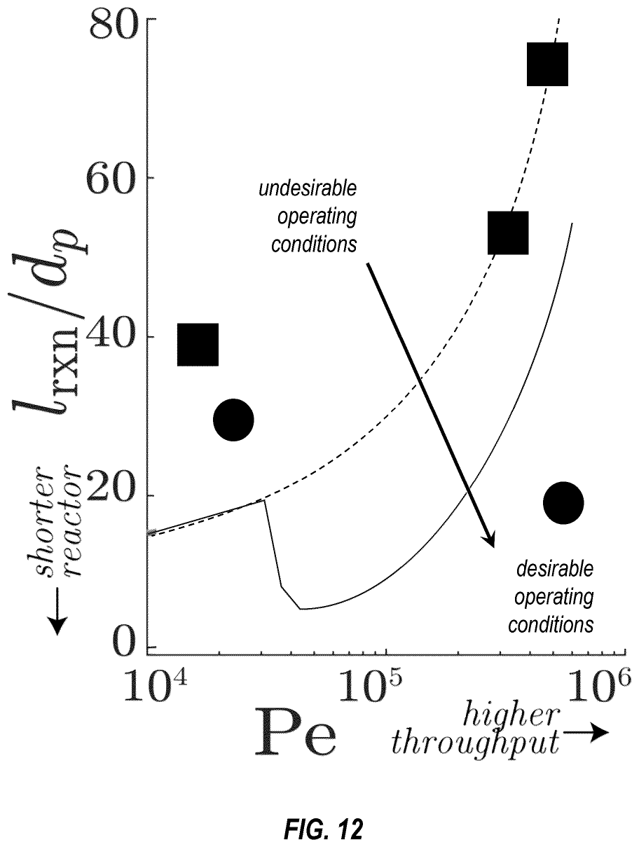

The solute transport model can quantitatively predict this improvement in reaction performance. For a transport-limited chemical reaction, the mixing time dominates the macro-scale reaction time tᵣₓₙ=tₘᵢₓ+tₘₒₗ. The reaction length is then given by our modeled mixing rate, which is the summation of LCA and EI mixing rates:

$$\frac{{l}_{mix}}{{d}_{p}} = Pe \frac{{r}_{mol}}{{t}_{d}} + {( \frac{{d}_{p}}{{l}_{mix , D}} + \frac{{t}_{mix , EI}^{- 1}}{{t}_{d} Pe} )}^{- 1} \qquad ( 3 )$$

where t_{d}=dₚ²/ [symbol] is a characteristic time of diffusion. The polymer-free solvent shows reduced reactor performance with increasing throughput Pe, providing a fit for tₘₒₗ≈2 min (dashed line in FIG. 12). Our transport model for t_{mix,EI}⁻¹≈Γ_{EI}f_{EI}f_{P}, validated for an unreactive solute, can then be inserted into this model to reasonably predict the increased reaction rate of our different reactive solute (solid line in FIG. 12).

As disclosed herein, it will be understood that, in some embodiments, providing the first carrier fluid may include injecting the first carrier fluid and the second carrier fluid into the geometry of interest at predetermined operating flow conditions. In some embodiments,

Referring again to FIG. 2, the method may include adjusting 240 the flow rate and/or decrease in pressure to the extent of improvement, which can be optimized empirically for each application's fluid and geometry.

In some embodiments, a control loop is utilized, where a sensor disposed in a flow path after the porous media, may be configured to determine the extent to which mixing (e.g., via an optical detector, measuring conductivity across electrodes, etc.), a reaction (e.g., via a pH meter, an optical detector, a chemical sensor, etc.), and/or a heat transfer (e.g., via a temperature sensor, etc.) has occurred. Based on the data from that sensor, circuitry (which may include a processor) may be configured to control a pump flow rate. The pump may adjust a flow rate of the polymer solution. The pump may adjust a flow rate of a carrier fluid. The pump may adjust a concentration of the polymer in the first carrier fluid.

The method may include estimating 201 or modeling some or all of the process.

The method may include estimating the improvement in the rate of mixing or reaction kinetics for a priori process design. The estimating process may include characterizing 202 the rheology of a modified carrier fluid comprising the first carrier fluid and the high molecular weight polymer using a shear rheometer to determine parameters including the shear-dependent normal stress, viscosity, and relaxation time. See, e.g., Example 2.

The estimating process may include determining 203 the shear-dependent Weissenberg number, based on the parameters, to estimate the onset of the elastic instability. For example, the various measurements may enable one to calculate one or more dimensionless quantities in the flow.

To characterize the role of polymer elasticity, a commonly-defined Weissenberg number Wi=λ\dot{γ}_{I}, is used, which compares the polymer relaxation time to the interstitial shear rate as a characteristic flow timescale. In the disclosed experiments, Wi ranges from 0.1 to 20 suggesting that viscoelastic flow instabilities likely arise in the flow. The use of Wi=λ\dot{γ}_{I} allows more ready graphical comparison with Pe˜Wi, in contrast with Pe˜ln(Wi_{I}). Rheology details above allow trivial conversion between the two; in this work, Wi_{I} ranges from 1 to 6.5, with an onset value Wi_{I,c,min}≈2.6, consistent with previous work.

One can also characterize the role of inertia with the Reynolds number Re=ρUdₚ/η(\dot{γ}_{I}), which quantifies the ratio of inertial to viscous stresses for a fluid with density ρ. In the disclosed experiments this quantity ranges from Re=2×10⁻⁷ to 2×10⁻⁵<<1, indicating that inertial effects are negligible and turbulence should not arise in any of the experiments.

The estimating process may include determining 204 a rate of dispersion and/or the dispersion-limited rate of reaction kinetics for the geometry of interest using a previously developed model. Such models are known in the art. See, e.g., Example 4.

The estimating process may include providing 205 an expected total elevated rate of mixing or reaction kinetics as a function of target operating conditions. As disclosed herein, this can be done in a variety of ways, for example, by using Equation (3).

In some embodiments, causing a flow rate and/or decrease in pressure may include selecting a target flow rate and/or pressure drop based on the expected total elevated rate of mixing or reaction kinetics expected total elevated rate of mixing or reaction kinetics. For example, one or more processors may, collectively, determine a more optimal operating condition, and may select an appropriate flow rate to achieve those operating conditions.

Especially for more complex porous media, such as soil, the various estimations may utilize certain factors to be taken into account. In some embodiments, determining a rate of dispersion and/or the dispersion-limited rate of reaction kinetics for the geometry of interest may include various substeps.

The substeps may include applying 207 one or more descriptors of a stratified porous medium and one or more descriptors of the polymer solution to an n-layer parallel resistor model for a flow of the polymer solution through the stratified porous medium, where n≥2, determining an onset condition of elastic turbulence in each layer and a nonlinear resistance to flow in each layer, and determining how the flow will partition across layers at a range of operating conditions based on the onset condition and the nonlinear resistance to flow. The descriptors of the stratified porous medium may include the number of strata, the permeability of each strata, or a combination thereof.

The substeps may include identifying 208 operating conditions that achieve a desired flow partitioning. The identified operating conditions may include a target rheology of the polymer solution.

The sub steps may include determining 206 one or more descriptors of a polymer solution, before identifying the operating conditions that achieve a desired flow partitioning. The descriptors of the polymer solution may include one or more rheological parameters.

The substeps may include repeating the steps of determining and applying in order to test different polymer solution rheologies before identifying the operating conditions that achieve the desired flow partitioning.

The substeps may include determining 209 a change to the polymer solution that is required to achieve the desired flow partitioning. The change to the polymer solution may include a change to one or more concentrations within the polymer solution, or the addition or removal of one or more high molecular weight polymers to or from the polymer solution.

### Example 5—Stratified Porous Media (Soil)

To investigate the spatial distribution of flow in a stratified porous medium, we use imaging at two different length scales (FIG. 1A): macro-scale (˜100s pores) and pore-scale (˜1 pore).

Macro-Scale Experiments in a Hele-Shaw Assembly

To characterize the macro-scale partitioning of flow, an unconsolidated stratified porous medium in a Hele-Shaw assembly was fabricated. An open-faced rectangular cell was 3D printed with span-wise (y-z-direction) cross-sectional area A=3 cm×0.4 cm and stream-wise (x-direction) length L=5 cm using a clear methacrylate-based resin (FLGPCL04, Formlabs Form3). To ensure an even distribution of flow at the boundaries, three inlets and outlets equally-spaced along the cross-section were used. The cell was filled with spherical borosilicate glass beads of distinct diameters arranged in parallel strata using a temporary partition, with bead diameters dₚ=1000 to 1400 μm (Sigma Aldrich) and 212 to 255 μm (Mo-Sci) for the higher-permeability coarse (subscript C) and lower-permeability fine (subscript F) strata, respectively. The strata have equal cross-sectional areas A_{C}≈A_{F}≈A/2 and thus their area ratio Ã≡A_{C}/A_{F}≈1. Steel mesh with a 150 μm pore size cutoff placed over the inlet and outlet tubing prevents the beads from exiting the cell. The beads were tamped down for 30 min to form a dense random packing with a porosity ϕ_{V}˜0.4. The whole assembly was screwed shut with an overlying acrylic sheet cut to size, sandwiching a thin sheet of polydimethylsiloxane to provide a watertight seal.

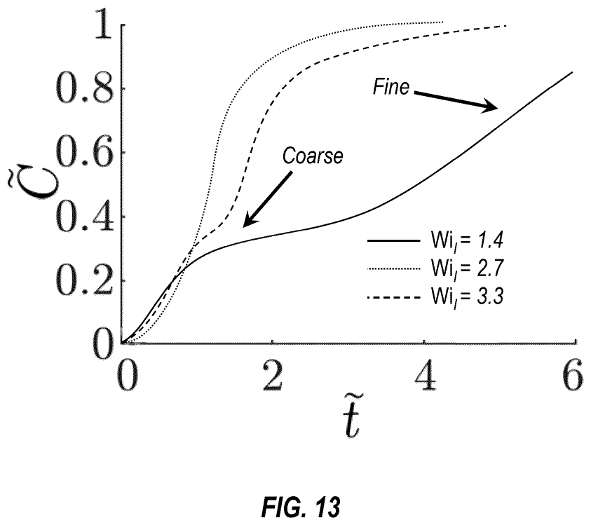

For all macro-scale experiments, a Harvard Apparatus PHD 2000™ syringe pump was used to first introduce the test fluid—either the polymer solution or the polymer-free solvent, which acts as a Newtonian control—at a constant flow rate Q for at least the duration needed to fill the entire pore space volume t_{PV} ≡ϕ_{V}AL/Q before imaging to ensure an equilibrated starting condition. The macro-scale scalar transport by the fluid was visualized by introducing a step change in the concentration of a dilute dye (0.1 wt. % green food coloring) and recording the infiltration of the dye front using a DSLR camera (Sony α6300). To track the progression of the dye as it is advected by the flow, the “breakthrough” curve halfway along the length of the medium (x=L/2) was determined by measuring the dye intensity C averaged across the entire medium cross-section, normalized by the difference in intensities of the final dye-saturated and initial dye-free medium, C and C, respectively: \tilde{C}≡( [symbol] C [symbol] _{y}− [symbol] C₀ [symbol] _{y})/( [symbol] C_{f} [symbol] _{y}− [symbol] C₀ [symbol] _{y}) (see FIG. 13). For all breakthrough curves thereby measured, time t is normalized using the time taken to reach this halfway point, \tilde{t}≡t/(0.5 t_{PV}). Repeating this procedure for individual strata (subscript i) and tracking the variation of the stream-wise position Xᵢ at which \tilde{C}ᵢ=0.5 with time provides a measure of the superficial velocity Uᵢ=dXᵢ/dt in each stratum. In between tests at different flow rates, the assembly was flushed with the dye-free solution for at least ten pore volumes to remove any residual dye.

Pore-Scale Experiments in Microfluidic Assemblies

To gain insight into the pore-scale physics, experiments in consolidated microfluidic assemblies were used. Spherical borosilicate glass beads (Mo-Sci) were packed in square quartz capillaries (A=3.2 mm×3.2 mm; Vitrocom), densify them by tapping, and lightly sinter the beads—resulting in dense random packings again with ϕ_{V}˜0.4. This protocol was used to fabricate three different microfluidic media: a homogeneous higher-permeability coarse medium (dₚ=300 to 355 μm), a homogeneous lower-permeability fine medium (dₚ=125 to 155 μm), and a stratified medium with parallel higher-permeability coarse and lower-permeability fine strata, each composed of the same beads used to make the homogeneous media, again with equal cross-section areas, Ã≈1. The fully-developed pressure drop ΔP were measured across each medium using an Omega PX26 differential pressure transducer.

For all pore-scale experiments, before each experiment, the medium to be studied were first infiltrated with isopropyl alcohol (IPA) to prevent trapping of air bubbles and then displace the IPA by flushing with water. The water is then displaced with the miscible polymer solution, seeded with 5 ppm of fluorescent carboxylated polystyrene tracer particles (Invitrogen), Dₜ=200 nm in diameter. This solution is injected into the medium at a constant volumetric flow rate Q using Harvard Apparatus syringe pumps—a PHD 2000™ syringe pump for Q>1 mL/hr or a Pico Elite™ syringe pump for Q<1 mL/hr—for at least 3 hours to reach an equilibrated state before flow characterization. After each subsequent change in Q, the flow is given 1 hour to equilibrate before imaging. The flow in individual pores is monitored using a Nikon A1R+ laser scanning confocal fluorescence microscope with a 488 nm excitation laser and a 500-550 nm sensor detector; the tracer particles have excitation between 480 and 510 nm with an excitation peak at 505 nm, and emission between 505 and 540 nm with an emission peak at 515 nm. These particles are faithful tracers of the underlying flow field since the Péclet number Pe≡(Q/A)Dₜ/D>10⁵>>1, where D=k_{B}T/(3πηDₜ)=6×10⁻³ μm²/s is the Stokes-Einstein particle diffusivity. The flow was visualized using a 10× objective lens with the confocal resonant scanner, obtaining successive 8 μm-thick optical slices at a z depth˜100s μm within the medium. The imaging probed an x-y field of view 159 μm×159 μm at 60 frames per second for pores with dₚ=125 to 155 μm or 318 μm×318 μm at 30 frames per second for pores with dₚ=300 to 355 μm.

To monitor the flow in the different pores over time, an “intermittent” imaging protocol was used. Specifically, the flow was recorded in multiple pores chosen randomly throughout each medium (19 and 20 pores of the homogeneous coarse and fine media, respectively) for 2 s-long intervals every 4 min over the course of 1 h. For the experiments in homogeneous fine and stratified media, this protocol was complemented with “continuous” imaging in which the flow was monitored successively in 10 pores of the homogeneous fine medium for 5 min-long intervals each. For ease of visualization, the successive images thereby obtained were intensity-averaged over a time scale≈2.5 μm/(Q/A), producing movies of the tracer particle pathlines that closely approximate the instantaneous flow streamlines.

Permeability Measurements

For each medium, we determine the permeability via Darcy's law using experiments with pure water. For the microfluidic assemblies, k_{C}=79 μm² and k_{F}=8.6 μm² were obtained for the homogeneous coarse and fine media, respectively. The permeability ratio between the two strata is then \tilde{k}≡k_{C}/k_{F}≈9. The measured permeability for the entire stratified porous medium is k=32 μm², in reasonable agreement with the prediction obtained by considering the strata as separated homogeneous media providing parallel resistance to flow, k≈Ãk_{C}+(1−Ã)k_{F}≈44 μm².

The permeability of an isolated stratum in a stratified medium varies as ˜dₚ², similar to a homogeneous porous medium. Hence, for the Hele-Shaw assembly, the permeability of each stratum was estimated by scaling k_{C} and k_{F} with the differences in bead size. It was thereby estimated k≈440 μm² (\tilde{k}≈26) for the entire stratified medium, in reasonable agreement with the measured k=270 μm².

For both assemblies, a characteristic shear rate of the entire medium γ_{I}≡Q/Aϕ_{V}k was defined as the ratio between the characteristic pore flow speed Q/(ϕ_{V}A) and length scale k/ϕ_{V}. This example explored the range \dot{γ}_{I}≈0.2 to 26 s⁻¹.

Polymer Solution Rheology

The polymer solution is a Boger fluid comprised of dilute 300 ppm 18 MDa partially hydrolyzed polyacrylamide (HPAM) dissolved in a viscous aqueous solvent composed of 6 wt. % ultrapure milliPore water, 82.6 wt. % glycerol (Sigma Aldrich), 10.4 wt. % dimethylsulfoxide (Sigma Aldrich), and 1 wt. % NaCl. This solution is formulated to precisely match its refractive index to that of the glass beads—thus rendering each medium transparent when saturated. From intrinsic viscosity measurements the overlap concentration is c*≈0.77/[η]=600±300 ppm and the radius of gyration is R_{g}≈220 nm, and therefore, the experiments use a dilute polymer solution at ≈0.5 times the overlap concentration. The shear stress σ(γ_{I})=Aₛγ^{α}^{ₛ} and first normal stress difference N₁(γ_{I})=Aₙγ^{α}^{ₙ} are measured in an Anton Paar MCR301 rheometer, using a 1° 5 cm-diameter conical geometry set at a 50 μm gap, yielding the best-fit power laws A_{S}=0.3428±0.0002 Pa·s^{α}^{ₛ} with αₛ=0.931±0.001 and Aₙ=1.16±0.03 Pa·s^{α}^{ₙ} with αₙ=1.25±0.02.

These measurements enable calculation of the characteristic interstitial Weissenberg number, which characterizes the role of polymer elasticity in the flow by comparing the magnitude of elastic and viscous stresses. Here, Wi_{I}≡N₁(γ_{I})/(2σ(γ_{I})) was used. In these examples this quantity exceeds unity, ranging from 1 to 5.5, suggesting that viscoelastic flow instabilities arise in the flow, which is directly verified using flow visualization. The role of inertia is characterized with the Reynolds number Re=ρUdₚ/η(γI), which quantifies the ratio of inertial to viscous stresses for a fluid with density ρ. In these examples this quantity ranges from Re=2×10⁻⁷ to 2×10⁻⁵<<1, indicating that inertial effects are negligible.

Polymer Solution Homogenizes Flow Above a Threshold Weissenberg Number, Coinciding with the Onset of Elastic Turbulence

The stratified Hele-Shaw assembly was used to characterize the uneven partitioning of flow between strata at the macro-scale. First, a small flow rate Q=3 mL/hr was imposed, corresponding to Wi_{I}=1.4—below the onset of elastic turbulence at for homogeneous media. As is the case with Newtonian fluids, preferential flow was observed through the coarse stratum, indicated by the infiltrating dye front. Referring to FIG. 13, the infiltration of dye at different rates through the strata produces two distinct steps in the breakthrough curve for Wi_{I}=1.4, the first jump from \tilde{C}≈0 to 0.4 for \tilde{t} from 0 to about 3 corresponds to fluid infiltration of the coarse stratum, and the second jump from \tilde{C}≈0.4 to 0.8 for \tilde{t} from about 3 to about 6 corresponds to infiltration of the fine stratum. This uneven partitioning of flow is also reflected in the difference between the magnitudes of the superficial velocities U_{C}=130 μm/s and U_{F}=10 μm/s in the coarse and fine strata, respectively, corresponding to a ratio of U_{F}/U_{C}=0.075. Similar behavior was observed with a Newtonian control, which produced a similar ratio of (U_{F}/U_{C})₀=0.063 even at a larger imposed flow rate Q=35 mL/hr. Hence, at low Wi_{I}, polymer solutions recapitulate the uneven partitioning of flow across strata that is characteristic of Newtonian fluids. Next, the same experiment was repeated at a larger flow rate of Q=25 mL/hr—corresponding to a larger Wi_{I}=2.7. Surprisingly, under these conditions, the partitioning of flow is markedly less uneven. These observations are reflected in the dye breakthrough curve, as well: the previously distinct jumps in the concentration \tilde{C} begin to merge, as shown by comparing the various curves in FIG. 13. Indeed, the ratio between the superficial velocities in the fine and coarse strata U_{F}/U_{C}=0.16, ˜3× larger than in the laminar baseline given by the Newtonian control and the low Wi_{I}=1.4 solution tests. Therefore, to quantify this net improvement in flow homogenization, the velocity ratio was normalized by its Newtonian value, Ũ_{F}/Ũ_{C}≡(Ũ_{F}/Ũ_{C})/(Ũ_{F}/Ũ_{C})₀=2.6. This improvement in the flow homogenization is weaker at an even larger flow rate Q=45 mL/hr (corresponding to Wi_{I}=3.3); the corresponding velocity ratio is Ũ_{F}/Ũ_{C}=1.7. Taken together, the observations demonstrate that high-molecular weight polymer additives can help mitigate uneven partitioning of flow in a stratified porous medium—but that this effect is optimized at intermediate Wi_{I}.

To shed light on the underlying physics, the “continuous” imaging protocol can be used to directly image the flow at the pore scale within the stratified microfluidic assembly. At the intermediate Wi_{I}=2.7—at which the flow homogenization is optimized—all pores observed in the fine stratum exhibit laminar flow that is steady over time. By contrast, 20% of the pores observed in the coarse stratum exhibit strong spatial and temporal fluctuations in the flow. The fluid streamlines continually cross and vary over time, indicating the emergence of an elastic instability.

At the even larger Wi_{I}=3.3—at which the improvement in flow homogenization is weaker—a larger fraction of pores in both strata exhibit unstable flow. These results thus suggest that macroscopic flow homogenization is linked to the onset of elastic turbulence in the coarse stratum at sufficiently large Wi_{I}, but is mitigated by the additional onset of elastic turbulence in the fine stratum at even larger Wi_{I}.

Flow Fluctuations Generated by Elastic Turbulence Lead to an Increase in the Apparent Viscosity

To quantitatively understand the link between pore-scale differences in this flow instability and macro-scale differences in superficial velocity between strata, the resistance to flow in the distinct strata at different Wi_{I} was considered. In particular, the strata were modeled as parallel fluidic “resistors”—that is, each stratum was treated as a homogeneous porous medium (e.g., coarse C or fine F), with the two hydraulically connected only at the inlet and outlet with fully-developed flow in each. Because the time-averaged pressure drop [symbol] ΔP [symbol] ₜ is equal across both strata, the imposed constant volumetric flow rate Q must partition into the coarse and fine strata with flow rates Q_{C} and Q_{F}, respectively, in proportion to their individual flow resistances via Darcy's law:

$$\frac{〈 Δ P {〉}_{t}}{L} = \frac{{η}_{app , C} {Q}_{C}}{{k}_{C} {A}_{C}} = \frac{{η}_{app , F} {Q}_{F}}{{k}_{F} {A}_{F}} \qquad ( 4 )$$

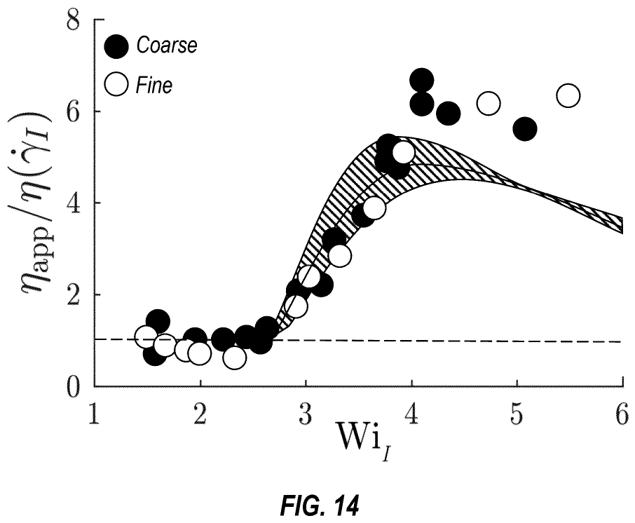

Macro-scale pressure drop measurements were combined with pore-scale flow visualization to determine and validate a model for the η_{app,i} of each stratum in isolation. This model was then used to deduce the apparent viscosity and uneven partitioning of flow within a stratified medium. To do so, the time-averaged pressure drop [symbol] ΔP [symbol] ₜ was measured at different volumetric flow rates Q across each microfluidic assembly. Darcy's law was used to determine the corresponding ηₐₚₚ, which was plotted as a function of Wi_{I} in FIG. 14. As expected, at small Wi_{I} 2.6, the apparent viscosity ηₐₚₚ is given by the bulk solution shear viscosity η(γI), indicated by the dashed line. However, above a threshold Wi_{C}=2.6, ηₐₚₚ rises sharply. Both the homogeneous coarse (solid circles) and fine (open circles) media exhibit a similar dependence of ηₐₚₚ on Wi_{I}—indicating that for the geometrically-similar packings, ηₐₚₚ (Wi_{I}) does not depend on grain size dₚ. To model this dependence of ηₐₚₚ on Wi_{I}, the pore-scale flow in each homogeneous microfluidic assembly was directly imaged with confocal microscopy using the “intermittent” imaging protocol.

At small Wi_{I}<2.6, the flow is laminar in all pores. Above the threshold Wi_{C}=2.6, the flow in some pores becomes unstable, exhibiting strong spatiotemporal fluctuations. At progressively larger Wi_{I}, an increasing fraction of the pores becomes unstable. To directly compute the added viscous dissipation arising from these flow fluctuations, the instantaneous 2D velocities u were measure using particle image velocimetry (PIV). Subtracting off the temporal mean in each pixel yields the velocity fluctuation u′=u− [symbol] u [symbol] ₜ, from which the fluctuating component of the strain rate tensor s′=(∇u′+∇u′^{T})/2 were computed. The rate of added viscous dissipation per unit volume arising from these flow fluctuations is then given directly by [symbol] χ [symbol] ₜ=η [symbol] s′: s′ [symbol] ₜ, which can be estimated from the measured 2D velocity field. As anticipated, the overall rate of added dissipation per unit volume [symbol] χ [symbol] _{t,V} determined by averaging [symbol] χ [symbol] ₜ across all imaged pores increases with Wi_{I} above the threshold Wi_{C}=2.6 as a greater fraction of pores becomes unstable. Next, this procedure is repeated in the homogeneous fine medium. Intriguingly, the overall rate of added dissipation per unit volume [symbol] χ [symbol] _{t,V} does not significantly vary between media. Additionally measuring [symbol] χ [symbol] _{t,V} using the “continuous” imaging protocol in the homogeneous fine medium further corroborates this agreement. It is speculated that this collapse reflects that flow fluctuations do not have a characteristic length scale.

The data indicate that, for the examples disclosed here, differences in grain size between homogeneous porous media are well-captured by Wi_{I}. All the data is therefore fit by the single empirical relationship [symbol] χ [symbol] _{t,V}=Aₓ(Wi_{I}/Wi_{c}−1)^{α}^{ₓ}, with Aₓ=176±1 W/m³, αₓ=2.4±0.3, and Wi_{C}=2.6.

The pore-scale flow fluctuations generated by elastic turbulence are quantitatively linked to ηₐₚₚ (Wi_{I}). The power density balance for viscous-dominated flow relates the rate of work done by the fluid pressure P to the rate of viscous energy dissipation per unit volume: −∇·Pu=τ: ∇u, where τ and ∇u are the stress and velocity gradient tensors, respectively. Averaging this equation over time t and the entire volume V of a given porous medium, and decomposing the velocity field into the sum of a base temporal mean and an additional component due to velocity fluctuations, then yields:

$$\frac{〈 Δ P {〉}_{t}}{L} = \frac{{η}_{app} ( Q / A )}{k} \approx \frac{η ( {\dot{γ}}_{I} ) ( Q / A )}{k} + \frac{〈 χ {〉}_{t , V}}{( Q / A )} + \{ strain history effects \} \qquad ( 5 )$$

The first term on the right-hand side of Eq. 5 represents Darcy's law for the base temporal mean of the flow. The second term reflects the added viscous dissipation by the solvent induced by the unstable flow fluctuations. The final term represents additional contributions arising from the full dependence of stress i on polymer strain history in 3D, which is currently inaccessible in the disclosed experiments. However, previous measurements in the homogeneous course medium indicate that this final term is relatively small for the range of Wi_{I} considered, because the flow is quasi-steady and polymers do not accumulate appreciable Hencky strain over a duration of one polymer relaxation time λ. Therefore, for simplicity, one can consider just the first two terms, which yields the solid line in FIG. 14; the shaded region indicates the uncertainty in this model arising from the empirical fit of a power law. The modeled ηₐₚₚ (Wi_{I}) thereby obtained from the pore-scale imaging shows excellent agreement with the ηₐₚₚ obtained from the macro-scale pressure drop measurements for both homogeneous media, without using any fitting parameters, for Wi_{I} up to about 4. The slight discrepancies at larger Wi_{I} suggest that strain history effects play a non-negligible role in this regime. Nevertheless, as a first approximation, one can use the ηₐₚₚ (Wi_{I}) modeled using Eq. 5 (neglecting the last term describing strain history) to deduce the apparent viscosity η_{app,i} within each stratum.

Parallel-Resistor Model Recapitulates Experimental Measurements of Apparent Viscosity and Uneven Flow Partitioning

The model for the apparent viscosity η_{app,i} (Wi_{I}) was incorporated in the parallel-resistor model of a stratified medium described previously. Specifically, for a given imposed total flow rate Q, which corresponds to a given Wi_{I}, equations 4 and 5 were numerically solved (neglecting the last term) along with mass conservation (Q=Q_{F}+Q_{C}) to obtain the apparent viscosity ηₐₚₚ (Wi_{I}) for the entire stratified system.

Geometry-Dependence of Flow Homogenization

How do the onset of and extent of homogenization imparted by elastic turbulence depend on the geometric characteristics of a stratified porous medium? To address the question of how the onset of and extent of homogenization imparted by elastic turbulence depend on the geometric characteristics of a stratified porous medium, one can use the disclosed model to probe how the overall apparent viscosity ηₐₚₚ (Wi_{I}) and the flow velocity ratio Ũ_{F}/Ũ_{C}(Wi_{I}) depend on \tilde{k} and Ã.

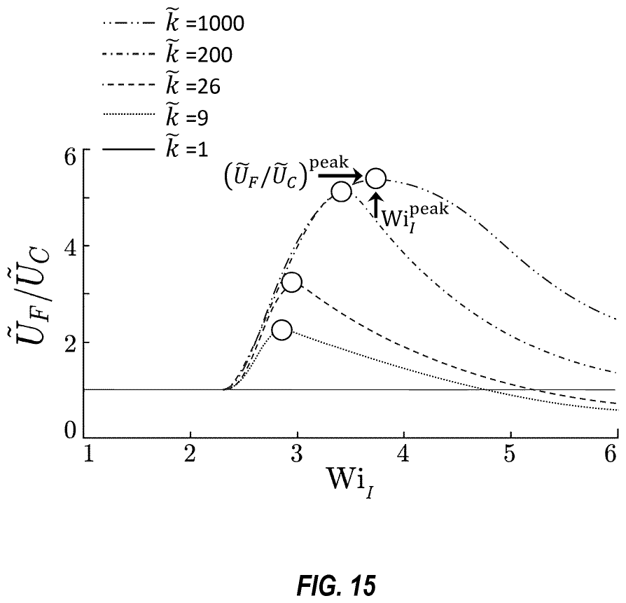

Despite the structural heterogeneity and uneven partitioning of the flow in a stratified medium, ηₐₚₚ (Wi_{I}) is not strongly sensitive to stratification; instead, it follows a similar trend to that of a homogeneous medium (\tilde{k}=1). The model further supports this finding; with increasing \tilde{k} (fixing Ã=1), the profile of ηₐₚₚ(Wi_{I}) shifts ever so slightly to smaller Wi_{I}, eventually converging to the same final profile for \tilde{k}>>100. However, the onset of elastic turbulence in the different strata does vary with increasing \tilde{k}: Wi_{c,C} correspondingly shifts to slightly smaller Wi_{I}, while Wi_{c,F} progressively shifts to larger Wi_{I}, reflecting the increasingly uneven partitioning of the flow imparted by increasing permeability differences. As a result, the strength of the flow homogenization generated by elastic turbulence, as well as the window of Wi_{I} at which it occurs, increases with \tilde{k} (see FIG. 15). This phenomenon is optimized at the peak position indicated by the open circles, which occur at Wi_{I}=Wi^{peak} with a flow velocity ratio (Ũ_{F}/Ũ_{C})^{peak}.

The results can be summarized by plotting both quantities as a function of \tilde{k}. Again, both increase until \tilde{k}≈400. For even larger \tilde{k}, Wi^{peak} plateaus at ≈3.7, while (Ũ_{F}/Ũ_{C})^{peak} peaks at ≈4.4 and continues to decrease. This behavior reflects the non-monotonic nature of the model for η_{app,i} (Wi_{I}); at such large permeability ratios, the coarse stratum reaches its maximal value of η_{app,C} at Wi_{I}<Wi_{c,F}, reducing the extent of flow redirection to the fine stratum generated by elastic turbulence in the coarse stratum. These physics are also reflected in the values of Wi^{peak} and Wi_{c,F}; while the two match for small \tilde{k}, Wi^{peak} becomes noticeably smaller than Wi_{c,F} for \tilde{k} greater than about 400.

Similar results arise with varying Ã (fixing \tilde{k}=9). Here, Ã<1 and Ã>1 describe the case in which a greater fraction of the medium cross-section is occupied by the fine or coarse stratum, respectively; the limits of Ã→0 and →∞ therefore represent a non-stratified homogeneous medium. While stratification again does not strongly alter ηₐₚₚ (Wi_{I}), it is found that Wi_{c,C}, Wi_{c,F}, and Wi^{peak} increase with Ã. Furthermore, (Ũ_{F}/Ũ_{C})^{peak} does not depend on Ã, since the superficial velocity incorporates cross-sectional area by definition. Taken together, these results provide quantitative guidelines by which the macroscopic flow resistance, as well as the onset and extent of flow homogenization, can be predicted for a porous medium with two parallel strata of a given geometry.

Extending the Model to Porous Media with Even More Strata

As a final demonstration of the utility of this approach, one can extend it to the case of a porous medium with n parallel strata, each indexed by i. To do so, one can again maintain the same pressure drop across all the different strata (Eq. 4), with the apparent viscosity η_{app,i} in each given by Eq. 5, and numerically solve these n−1 equations constrained by mass conservation, Q=Σⁿ Qᵢ.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method for increasing a mixing rate, heat transfer, or reaction rate of fluids, comprising:
providing a polymer solution comprising a first carrier fluid for use with a geometry of interest having an inlet and an outlet, the polymer solution having a high molecular weight polymer dissolved within the first carrier fluid; and
increasing a mixing rate, heat transfer, or reaction rate of the first carrier fluid and a second carrier fluid by producing a microscopic elastic flow instability, the microscopic elastic flow instability being produced by causing a flow rate and/or decrease in pressure of the first carrier fluid from the inlet to the outlet to exceed a predetermined threshold, and allowing the high molecular weight polymer to autonomously produce the microscopic elastic flow instability.

2. The method of claim 1, further comprising dissolving a predetermined amount of the high molecular weight polymer into the first carrier fluid;

3. The method of claim 1, wherein the first carrier fluid is an aqueous fluid.

4. The method of claim 1, wherein the first carrier fluid is a non-aqueous fluid.

5. The method according to claim 1, wherein the polymer solution further comprises one or more salts.

6. The method according to claim 1, wherein the polymer solution further comprises one or more additional solvents.

7. The method according to claim 1, wherein the polymer solution further comprises an oxidant, a colloid, and/or a surfactant.

8. The method according to claim 1, wherein the high molecular weight polymer comprises a polyacrylamide, a polylactic acid, a polyethyleneoxide, or a combination thereof.

9. The method of claim 1, wherein causing the flow rate and/or decrease in pressure of the first carrier fluid from the inlet to the outlet to exceed the predetermined threshold includes injecting the first carrier fluid and the second carrier fluid into the geometry of interest at predetermined operating flow conditions.

10. The method of claim 1, further comprising adjusting the flow rate and/or decrease in pressure to the extent of improvement.

11. The method of claim 1, further comprising estimating the improvement in the rate of mixing or reaction kinetics for a priori process design, by:
characterizing the rheology of a modified carrier fluid comprising the first carrier fluid and the high molecular weight polymer using a shear rheometer to determine parameters including the shear-dependent normal stress, viscosity, and relaxation time;
determining the shear-dependent Weissenberg number, based on the parameters, to estimate the onset of the elastic instability;
determining a rate of dispersion and/or the dispersion-limited rate of reaction kinetics for the geometry of interest using a previously developed model; and
providing an expected total elevated rate of mixing or reaction kinetics as a function of target operating conditions.

12. The method of claim 8, wherein causing a flow rate and/or decrease in pressure includes selecting a target flow rate and/or pressure drop based on the expected total elevated rate of mixing or reaction kinetics expected total elevated rate of mixing or reaction kinetics.

13. The method of claim 1, further comprising:
applying one or more descriptors of a stratified porous medium and one or more descriptors of the polymer solution to an n-layer parallel resistor model for a flow of the polymer solution through the stratified porous medium, where n≥2, computing an onset condition of elastic turbulence in each layer and a nonlinear resistance to flow in each layer, and determining how the flow will partition across layers at a range of operating conditions based on the onset condition and the nonlinear resistance to flow; and
identifying the operating conditions that achieve a desired flow partitioning.

14. The method according to claim 13, wherein the descriptors of the stratified porous medium comprise the number of strata, the permeability of each strata, or a combination thereof.

15. The method according to claim 13, wherein the descriptors of the polymer solution comprise one or more rheological parameters.

16. The method according to claim 13, wherein the identified operating conditions comprises a target rheology of the polymer solution.

17. The method according to claim 13, further comprising determining one or more descriptors of a polymer solution, before identifying the operating conditions that achieve a desired flow partitioning, repeating the steps of determining and applying in order to test different polymer solution rheologies before identifying the operating conditions that achieve the desired flow partitioning.

18. The method according to claim 17, further comprising determining a change to the polymer solution that is required to achieve the desired flow partitioning.

19. The method according to claim 18, wherein the change to the polymer solution comprises a change to one or more concentrations within the polymer solution, or the addition or removal of one or more high molecular weight polymers to or from the polymer solution.

20. A system for providing flow homogenization in stratified porous media, comprising:
a first pump configured to inject a polymer solution into a geometry of interest;
optionally a second pump configured to inject a second carrier fluid into the geometry of interest;
at least one sensor configured to measure a pressure and/or a flow rate; and
one or more processors configured with instructions that, when executed, causes the one or more processors to, collectively:
receive information from the at least one sensor; and
control the first pump and/or the second pump so as to increase a mixing rate, heat transfer, or reaction rate of a first carrier fluid and a second carrier fluid by producing a microscopic elastic flow instability, the microscopic elastic flow instability being produced by causing a flow rate and/or decrease in pressure of the first carrier fluid from the inlet to the outlet to exceed a predetermined threshold, and allowing the high molecular weight polymer to autonomously produce the microscopic elastic flow instability.
